(19) United States
(12) Patent Application Publication
(10) Pub. No.: US 2013/0169585 A1
(43) Pub. Date: Jul. 4, 2013

(54) CAPACITIVE TOUCH SCREEN APPARATUS

(71) Applicant: Sim Kok Choon, Singapore (SG)

(72) Inventor: Sim Kok Choon, Singapore (SG)

(21) Appl. No.: 13/342,739

(22) Filed: Jan. 3, 2012

(51) Int. Cl. G06F 3/044

(52) U.S. Cl. 345/174

(57) ABSTRACT

A touch screen apparatus and associated methods are disclosed. In one embodiment, a touch screen apparatus includes a touch screen sensor grid including a first electrode and a second electrode. The first electrode includes a cavity in which a ground electrode is disposed. The second electrode is disposed above the ground electrode.

### BACKGROUND

1. Technical Field

This disclosure relates to touch screens, and more particularly, to capacitive touch screens.

2. Description of the Related Art

Touch screens have found widespread application in recent years. Smart phones and tablet computers are just two of a wide variety of systems in which touch screens are used as input devices. In general, a touch screen is an electronic visual display through which a user can interact with a system by touching the screen with a finger or a stylus. Touch screens come in various types. A category of touch screens that operate based on the changing of capacitance values when touched are referred to as capacitive touch screens.

### SUMMARY OF THE DISCLOSURE

A touch screen apparatus is disclosed. In one embodiment, a touch screen apparatus includes a touch screen sensor grid including a first electrode and a second electrode. The first electrode includes a cavity in which a ground electrode is disposed. The second electrode is disposed above the ground electrode.

In one embodiment, a method includes generating an electric field between a first electrode and a second electrode of a touch screen apparatus. The first electrode includes a cavity in which a ground electrode is disposed. The second electrode disposed above the ground electrode. The method further includes detecting a change of the electric field responsive to a touch of the touch screen apparatus.

### BRIEF DESCRIPTION OF THE DRAWINGS

Other aspects of the disclosure will become apparent upon reading the following detailed description and upon reference to the accompanying drawings, which are now described as follows.

FIG. 1 is an illustration of one embodiment of an electronic device including a touch screen.

FIGS. 2A-2D are illustrations of the various layers of one embodiment of a touch screen apparatus.

FIG. 3 is a side view illustrating the various layers of one embodiment of a touch screen apparatus.

FIG. 4 is a schematic diagram illustrating one embodiment of an electrical circuit formed using an embodiment of a touch screen apparatus.

FIG. 5 is a flow diagram illustrating one embodiment of a method for operating a touch screen apparatus.

While the invention is susceptible to various modifications and alternative forms, specific embodiments thereof are shown by way of example in the drawings and will herein be described in detail. It should be understood, however, that the drawings and description thereto are not intended to limit the invention to the particular form disclosed, but, on the contrary, the invention is to cover all modifications, equivalents, and alternatives falling within the spirit and scope of the present invention as defined by the appended claims.

### DETAILED DESCRIPTION

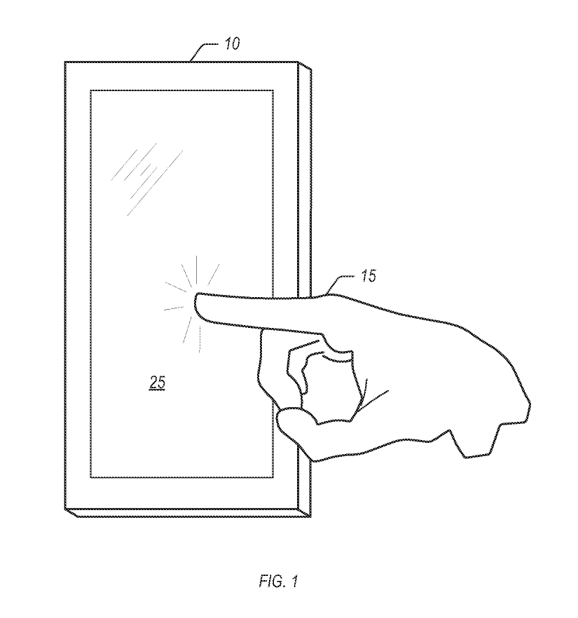

Turning now to FIG. 1, an illustration of one embodiment of a portable electronic device including a touch screen apparatus is shown. Portable electronic device 10 in the illustrated example may be one of a number of different types of devices, such as a smart phone, a tablet computer, or other type of device. Touch screen apparatus 25 of portable electronic device 10 provides a user interface in the embodiment shown. The touch screen apparatus 25 may be used as a device in which users provide input to portable electronic device 10, as well as a device in which responses to user inputs and other processing actions are displayed. Responsive to touch by finger 15 as shown in the illustration, portable electronic device 10 may perform various processing functions that may cause the information displayed to be updated. It is noted that in some embodiments, a stylus or other type of object may be used to provide user input to portable electronic device 10 in lieu of the finger shown in the illustration. In general, the touch may be performed by any suitable object.

While the embodiment shown in FIG. 1 is directed to a portable electronic device, touch screen apparatus 25 may be used in other implementations, which may or may not be portable. For example, an embodiment of touch screen apparatus 25 to be discussed further below may be implemented in a kiosk or other type of stationary display or exhibit as well as in other suitable devices.

In one embodiment, touch screen apparatus 25 may implement a capacitive touch screen. A capacitive touch screen is one in which a touch of the touch screen alters the capacitance between electrodes implemented therein. The change in capacitance may in turn result in a change in an amount of current or charge received by a receiver circuit. Detection of the change of current or charge may indicate that the touch screen has been touched. Touch screen apparatus 25 may include a number of transmit electrodes and receive electrodes arranged across the area spanned by the touch screen. Corresponding electric fields may be formed between transmit and receive electrodes where they overlap in area. Thus, when a particular electric field is disturbed responsive to a touch of the touch screen, circuitry coupled to the touch screen apparatus 25 may detect the location of the touch. Responsive to detecting the touch and its location, the circuitry may perform additional processing that may cause the information displayed on the touch screen to be updated, among other actions.

In some devices, it may be desirable to limit the thickness of touch screens and the corresponding apparatus embodiments in which they are implemented. In a thinner panel design, the mutual capacitance between the transmit and receive electrodes may be more tightly coupled. Reducing the overlap between the transmit and receive electrodes may help maintain the mutual capacitance at or near a desired value even if the relative geometry therebetween changes as a result of a temperature change. Various embodiments of such a touch screen apparatus will now be discussed in further detail.

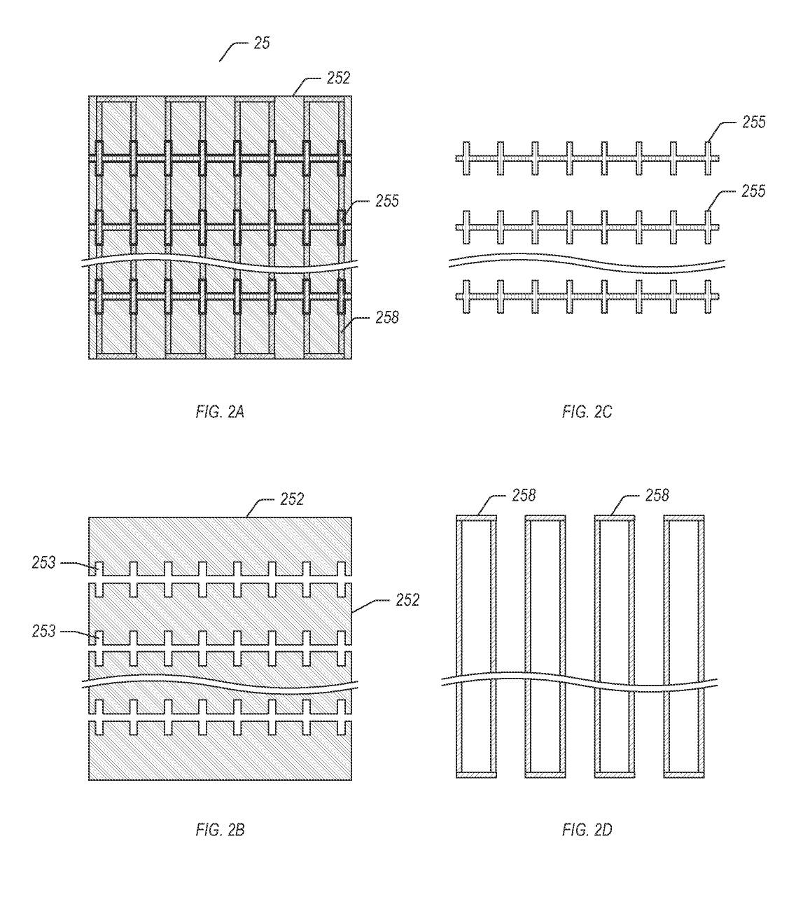

Turning now to FIGS. 2A-2D, a top view of a portion of various components of touch screen apparatus 25 is shown. FIG. 2A illustrates a composite view of the electrode arrangement of touch screen apparatus 25, while FIGS. 2B-2D illustrate the individual electrode types. It is noted that the embodiments shown in FIGS. 2A-2D illustrate a portion of the overall area occupied by the different electrodes of touch screen apparatus 25 in various embodiments. It is further noted that the shapes of the various electrodes illustrated here are exemplary, and that such electrodes may be implemented using other shapes while still falling within the scope of this disclosure.

In the illustrated embodiment, touch screen apparatus 25 includes a number of transmit electrodes 252, a number of receive electrodes 258, and a number of ground electrodes 255. The area occupied by each of transmit electrodes 252 overlaps a portion of the area occupied (in another plane) by each of a number of receive electrodes 258. Similarly, the area occupied by each of receive electrodes 258 overlaps a portion of the area occupied by each of the transmit electrodes 252. As will be illustrated in further detail below, each of the transmit electrodes may be coupled to a corresponding driver circuits, while each of receive electrodes 258 may be coupled to a corresponding receiver. When the transmitter and receiver circuits are active, electric fields may be formed between overlapping portions of transmit electrodes 252 and receive electrodes 258. When touch screen apparatus 25 is touched by a user, at least one of the electric fields may be disturbed due to a change in the capacitance resulting from the touch. The change in the electric field (and more particularly, change in current or charge received by a corresponding receiver) may in turn provide an indication of both the occurrence and location of the touch.

As noted above, reducing the overlapping area between transmit and receive electrodes may reduce some of the mutual capacitance therebetween and thus reduce the impact of unintended changes to the geometry of the electrodes (e.g., due to temperature changes). In the embodiment shown, cavity areas 253 are slots formed in each of transmit electrodes 252. The cavity areas 253 are formed in locations that reduce the overlapping area with receive electrodes 258 when touch screen apparatus 25 is fully assembled.

In the composite assembly shown in FIG. 2A, the transmit electrodes 252 and receive electrodes 258 are arranged in proximate to one another. The receive electrodes 258 are located in a layer/plane arranged above (i.e., closer to the outer surface of the touch screen apparatus 25) the layer/plane in which the transmit electrodes 252 are located. Furthermore, the transmit electrodes 252 are arranged closer to the electronics of the system in which touch screen apparatus 25 is implemented. Since the electronics of the device may generate noise or interference that can affect operation of the touch screen apparatus, ground electrodes 255 are implemented to provide shielding between the device electronics and the receive electrodes 258. In the embodiment shown, the ground electrodes 255 are shaped such that they may substantially occupy the area between individual instances of the transmit electrodes 252. Furthermore, the shape of the ground electrodes in this embodiment is such that they also occupy the cavity areas 253 of the transmit electrodes. In one embodiment, the ground electrodes 253 may further be implemented in the same layer/plane as the transmit electrodes 252. In another embodiment, the layer in which the ground electrodes are implemented may overlap the layer of the transmit electrodes, even if they are otherwise not co-planar. Accordingly, transmit electrodes 252 in combination with ground electrodes 255 may shield receive electrodes 258 from noise generated by the electronics of the device in which touch screen apparatus 25 is implemented. Accordingly, the configuration shown in the illustrated embodiment may allow for reducing the overlap between transmit electrodes 252 and receive electrodes 258 while also providing the shielding from electronic noise as described above.

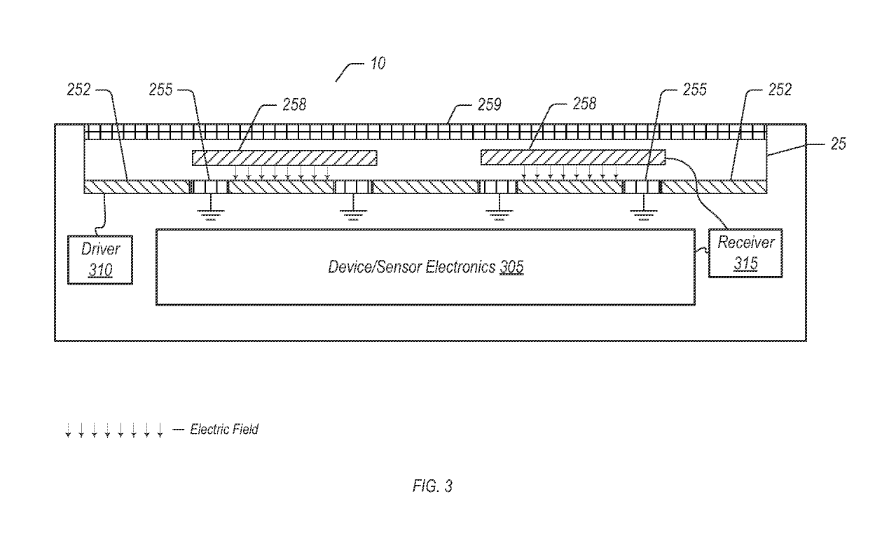

Turning now to FIG. 3, a side view of one embodiment of a portable electronic device 10 including touch screen apparatus 25 is shown. In the embodiment shown, touch screen apparatus 25 includes a transparent (or at least partially transparent), surface 259, which may be comprises of an electrically insulating material, and which may additionally be a dielectric material. The surface 259 is arranged as the outermost layer of touch screen apparatus 25, and may thus act as the touch surface through which a user may provide input to portable electronic device 10. When a user touches surface 259, either with a finger or other type of object (e.g., a stylus), the capacitance in the corresponding location may be altered, thereby altering one or more electrical fields in that location.

In addition, information may be displayed through the transparent, surface 259. Although not explicitly shown here, portable electronic device may include one or more liquid crystal displays (LCDs), light emitting diode (LED) displays, or other type of display apparatus that may emit light through surface 259. The displayed information may include icons, text, and any other type of information which may be generated by portable electronic device 10. A user may interact with portable electronic device 10 by touching the surface 259 at various points. The information displayed by the device may be updated responsive to a user touch.

In FIG. 3, the planar relationships between transmit electrodes 252, receive electrodes 258 and ground electrodes 255 are shown for one embodiment. In the embodiment shown, receive electrodes are arranged in a layer that is underneath that of surface 259, while being above (but in the proximity) the plane of transmit electrodes 252. In turn, the transmit electrodes 252 are arranged in a plane that is above the device/sensor electronics 305 but below the plane of receive electrodes 258. In the illustrated embodiment, ground electrodes 255 are arranged to have substantially the same planar relationship with receive electrodes 258 as transmit electrodes 252. Thus, in accordance with both FIG. 3 and the arrangement shown in FIGS. 2A-2D, ground electrodes 255 occupy the space between individual instances of transmit electrodes 252, as well as the cavity areas 253 of each transmit electrode 252. Therefore, transmit electrodes 252 and ground electrodes 255 may shield receive electrodes 258 from electronic noise that may be emitted by device/sensor electronics 305.

In the embodiment shown, each transmit electrode 252 is coupled to a corresponding driver circuit 310. Similarly, each receive electrode 258 is coupled to a receiver circuit 315. One instance each of driver circuit 310 and receiver circuit 315 are shown here for the sake of simplicity, although it is understood that multiple instances of each may be provided. Each driver circuit 310 may generate a voltage that is provided to its correspondingly coupled transmit electrode 252. Each receiver circuit 315 may receive an electrical current or charge from its correspondingly coupled receive electrode 258. As noted above, when a driver circuit 310 coupled to a transmit electrode 252 and a receiver circuit 315 coupled to an overlapping receiver circuit 315 are both active, an electrical field may be formed in the space between the overlapping electrodes. This electric field may remain substantially constant in strength when undisturbed. When a touch occurs to the surface 259 in a location overlapping the area of the electric field (or close thereto in some cases), the electric field may be altered, and thus the electrical current or charge received by receiver circuit 315 may be correspondingly altered. Thus, a change to the electrical current or charge received by a given receiver circuit 315 may be interpreted as a touch of the touch screen.

In the embodiment shown, device/sensor electronics 305 may include one or more sensing circuits coupled to one or more of the receiver circuits 315. Based on which receiver circuits 315 report a change in received current or charge, sensing circuits within device/sensor electronics 305 may determine an approximate location on the surface 259 at which the touch occurred. Based on the touch, an appropriate response may be generated. Exemplary responses include (but are not limited to) updating or changing information, initiating a phone call, answering a phone call, typing a character of a text message, sending a text message, invoking an application, and so on.

In addition to the sensing circuitry discussed above, device/sensor electronics 305 may include various other types of circuits. Such circuits may include (but are not limited to) general-purpose processors/processor cores, graphics processors, various types of radio transceivers, audio processing circuitry, and so on. The circuitry of device/sensor electronics 305 may be implemented using one or more integrated circuits. In additional, some portions of device/sensor electronics may be implemented using one or more discrete components.

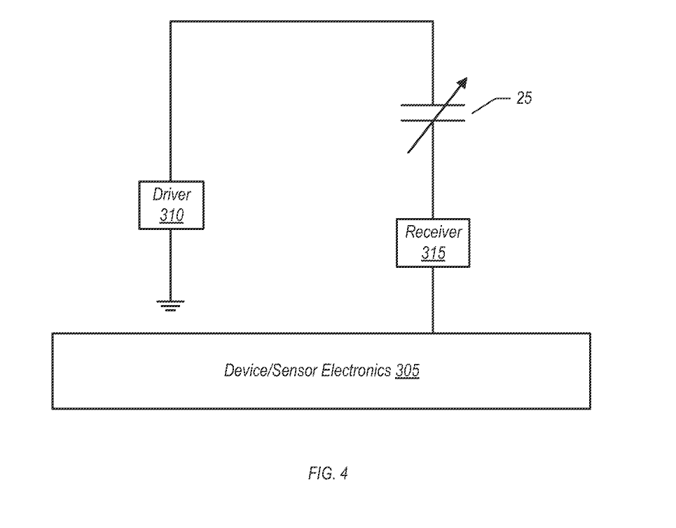

FIG. 4 is a diagram illustrating the electrical circuit formed overlapping portions of a transmit electrode and a receive electrode and their correspondingly coupled driver and receiver circuits, respectively. In the embodiment shown, touch screen apparatus 25 is represented by a variable capacitance. The capacitance between a transmit electrode 252 and an overlapping portion of a receive electrode may be considered variable due to the change that occurs responsive to a touch in the corresponding proximity. As noted above, driver circuit 310 may generate a voltage that is provided to the transmit electrode 252 of the overlapping portions. Receiver circuit 315 may be coupled to the receive electrode 258 of the overlapping portions. In one embodiment, driver circuit 310 may generate an alternating current (AC) voltage. Accordingly, receiver circuit 315 may receive an AC signal via the formed capacitor. When a touch alters the capacitance of the overlapping sections of the transmit electrode 252 and the receive electrode 258, the current of the AC signal may change accordingly. This change in current may be detected by receiver circuit 315 and reported to device/sensor electronics 305, which may then determine the location upon which the touch occurred.

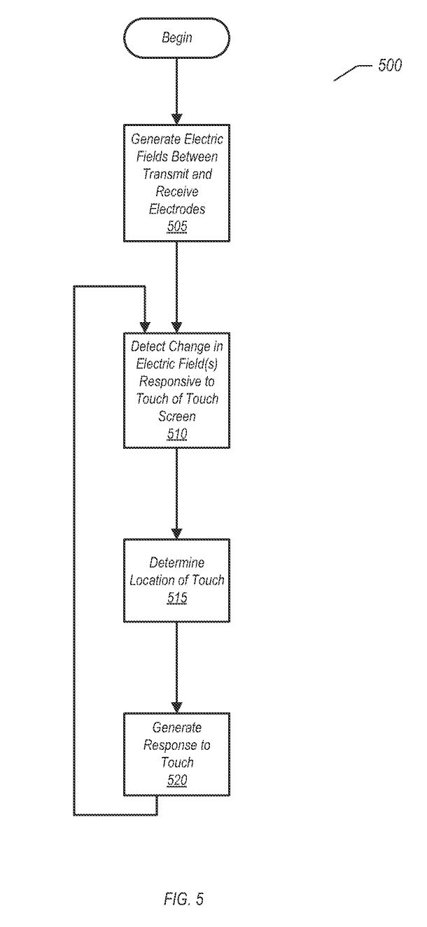

FIG. 5 is a flow diagram illustrating one embodiment of a method for operating a touch screen apparatus. The methodology described herein and illustrated by FIG. 5 may be applied to the various embodiments of touch screen apparatus 25 discussed above, among others.

Method 500 begins with the generation of electric fields between transmit electrodes and receive electrodes of a touch screen apparatus (block 505). The electric fields may be generated based on a capacitance between overlapping portions of transmit and receive electrodes of a touch screen apparatus. The electrodes may be arranged such that ground electrodes fill in gaps between and in the transmit electrodes t shield the receive electrodes from electronic noise generated by other circuits in the system in which the touch screen apparatus is implemented.

The method further includes detecting a change in at least one of the electric fields responsive to a touch of the touch screen (block 510). The change in the electric field may result from a change in capacitance between transmit and receive electrodes in the proximity of the touch. The change in the electric field may be detected via a change in current received by a receiver circuit coupled to a corresponding receive electrode. The detection of the changing current may be reported to sensor electronics in one embodiment, which may in turn determine the location of the touch (block 515). The system in which the touch screen apparatus is implemented may generate a system response to the touch upon its detection and determination of its location (block 520). The responsive may include one of a number of different actions, some of which may include an update of the information displayed on the touch screen. The method may return to block 510 and repeat blocks 510, 515, and 520 for each touch of the touch screen.

While the present invention has been described with reference to particular embodiments, it will be understood that the embodiments are illustrative and that the invention scope is not so limited. Any variations, modifications, additions, and improvements to the embodiments described are possible. These variations, modifications, additions, and improvements may fall within the scope of the inventions as detailed within the following claims.

What is claimed is:

1. An apparatus comprising:
a touch screen sensor grid including a first electrode and a second electrode;
wherein the first electrode has a cavity in which a ground electrode is disposed, and wherein the second electrode is disposed above the ground electrode.

2. The apparatus as recited in claim 1, wherein the first electrode and the ground electrode are arranged in a first plane and wherein the second electrode is arranged in a second layer.

3. The apparatus as recited in claim 2, further comprising a surface layer arranged above the second electrode, wherein the surface layer is at least partially transparent.

4. The apparatus as recited in claim 1, wherein the first electrode is coupled to an output of a driver circuit, and wherein the second electrode is coupled to a receiver circuit.

5. The apparatus as recited in claim 4, wherein the driver circuit is configured to drive a signal onto the first electrode such that an electric field is formed between the first and second electrodes.

6. The apparatus as recited in claim 5, wherein the receiver circuitry is configured to detect a change in an electrical charge responsive to a change in the electric field resulting from an object touching the touch screen.

7. The apparatus as recited in claim 6, further comprising sensor circuitry coupled to the receiver circuit, wherein the sensor circuitry is configured to detect an approximate location of a touch of the touch screen.

8. The apparatus as recited in claim 1, wherein the first and second electrodes are arranged to reduce a change in a capacitance between the first and second electrodes resulting from a change in temperature.

9. A method comprising:
generating an electric field between a first electrode and a second electrode of a touch screen apparatus, wherein the first electrode includes a cavity in which a ground electrode is disposed, and wherein the second electrode disposed above the ground electrode; and
detecting a change of the electric field responsive to a touch of the touch screen apparatus.

10. The method as recited in claim 9 further comprising:
driving a first electrical signal from a driver circuit to the first electrode; and
receiving a second electrical signal from the second electrode at the receiver circuit.

11. The method as recited in 9, further comprising the ground electrode and the first electrode shielding the second electrode from electrical noise generated by one or more integrated circuits disposed beneath the first electrode and ground electrode.

12. The method as recited in claim 9, further comprising determining a location at which the touch screen apparatus was touched and updating information displayed on a display screen of the touch screen apparatus.

13. The method as recited in claim 12, further comprising reducing a change in a capacitance between the first and second electrodes resulting from a change in temperature.

14. A touch screen device comprising:
a receive electrode;
a transmit electrode arranged proximate to the receive electrode, wherein the transmit electrode includes at least one slot in which a ground electrode is disposed, and wherein the receive electrode is disposed above the ground electrode.

15. The touch screen device as recited in claim 14, wherein the transmit electrode and the ground electrode are arranged in a first plane, and wherein the receive electrode is arranged in a second plane.

16. The touch screen device as recited in claim 15, further comprising a surface arranged above the second electrode, wherein the surface is at least partially transparent.

17. The touch screen device as recited in claim 16, further comprising a driver circuit configured to provide a voltage to the transmit electrode, and a receiver circuit coupled to receive an electrical charge from the receive electrode.

18. The touch screen device as recited in claim 17, wherein the driver circuit is configured to drive a signal onto the transmit electrode such that an electric field is formed between the transmit and receive electrodes.

19. The touch screen device as recited in claim 17, wherein the receiver circuit is configured to detect a change in an amount of electrical charge received from the receive electrode responsive to an object touching the surface.

20. The touch screen device as recited in claim 14, wherein the transmit and receive electrodes are arranged to reduce a change in a capacitance between the transmit and receive electrodes resulting from a change in temperature.
